(19) United States
(12) Patent Application Publication
(10) Pub. No.: US 2005/0230145 A1
(43) Pub. Date: Oct. 20, 2005

(54) Thin-diameter coaxial cable and method of producing the same

(76) Inventors: Toku Ishii, Tokyo (JP); Shigehiro Matsuno, Tokyo (JP); Kazunori Watanabe, Gifu-shi (JP); Seiji Tanaka, Gifu-shi (JP)

Correspondence Address: JORDAN AND HAMBURG LLP, 122 EAST 42ND STREET, SUITE 4000, NEW YORK, NY, 10168, US

(21) Appl. No.: 10/523,884

(22) PCT Filed: Aug. 5, 2003
(86) PCT No.: PCT/JP03/09944

§ 371 Date: Mar. 23, 2005

(30) Foreign Application Priority Data
Aug. 6, 2002 (JP) 2002-228683

(51) Int. Cl. H01B 11/02

(52) U.S. Cl. 174/113 AS

(57) ABSTRACT

A small-diameter coaxial cable comprises a central conductor, an insulated covering layer arranged on the outer periphery of the central conductor and having air gaps continuous along the longitudinal direction and an outer conductor layer arranged on the outer periphery of the insulated covering layer. The insulated covering layer includes an inner annular portion covering the outer periphery of the central conductor, a plurality of coupling portions extending outward from the inner annular portion and an outer annular portion connecting the outer peripheral edges of the coupling portions to each other. Air gaps defined along the peripheral direction by the coupling portions are formed on the inner side of the insulated covering layer.

### TECHNICAL FIELD

The present invention relates to a small-diameter coaxial cable being superior in high-frequency characteristic and electrical characteristics and a method of fabricating the same.

### BACKGROUND ART

With the recent trend toward an increased information volume and an increased transmission speed, the coaxial cable has begun to be used for the antenna wire of the portable information terminals and the wires connecting the LCD and the CPU. On the other hand, the reduced size and thickness of the information terminals and notebook-sized personal computers requires a smaller diameter of the coaxial cable. Generally, to acquire the coaxial cable having superior electrical characteristics, it is crucial to decrease the dielectric constant of an insulated covering layer formed on the outer periphery of the central conductor as much as possible. For this purpose, the insulated covering layer is often formed of fluoro resin or polyolefin resin which is low in dielectric constant. Also, the foaming process is often employed to reduce the apparent dielectric constant.

In the case of the foaming extrusion technique, however, it is difficult to secure the extrusion stability. Especially, in the extrusion of a small-diameter component, the outer diameter of the insulated covering layer undergoes a delicate change, thereby causing the variation in the high-frequency characteristic and the electrical characteristics.

The coaxial cable can be effectively reduced in diameter, on the other hand, by using a metal plating layer instead of a braided metal wire as an outer conductor formed on the outer periphery of the insulated covering layer.

In the case where the insulated covering layer is foamed to reduce the apparent dielectric constant, however, the problem is posed that the plating solution intrudes into the bubbles of the foamed portion for an increased dielectric constant or corrodes the outer conductor thereby adversely affecting the electrical characteristics of the coaxial cable.

This invention has been developed in view of these problems of the prior art and the object thereof is to provide a small-diameter coaxial cable having the frequency characteristic and the electrical characteristics which are both superior and stable.

### DISCLOSURE OF THE INVENTION

In order to achieve the object described above, according to this invention, there is provided a small-diameter coaxial cable comprising a central conductor, an insulated covering layer arranged on the outer periphery of the central conductor and having air gaps continuous along the longitudinal direction and an outer conductor layer arranged on the outer periphery of the insulated covering layer, characterized in that the insulated covering layer includes an inner annular portion covering the outer periphery of the central conductor, a plurality of coupling portions extending outward from the inner annular portion and an outer annular portion connecting the outer peripheral edges of the coupling portions to each other, and the coupling portions define the peripheral direction of the air gaps.

In the small-diameter coaxial cable having this configuration, the provision of the air gaps defined by the coupling portions in the insulated covering layer reduces the equivalent dielectric constant and improves the high-frequency characteristic and the electrical characteristics.

This improvement can be attained without the expansion molding and therefore a high accuracy of outer diameter is obtained. At the same time, the elimination of the need of sizing makes possible a high-speed molding process. In the case where a plating layer (outer conductor) is formed on the outer annular portion, there is no likelihood that the plating solution intrudes in the bubbles thereby corroding the outer conductor.

In the small-diameter coaxial cable having this configuration, the inner annular portion and the coupling portions combined with the outer annular portion, the inner annular portion combined with the coupling portions and the outer annular portion, or the outer annular portion can be formed into double layers of different types of resin.

With this configuration, the insulated covering layer is preferably formed of fluoro resin having a small dielectric constant. The fluoro resin, however, has a low adhesion with the plating film and poses a problem in the case where the outer conductor layer is formed by plating. Nevertheless, the plating performance can be improved by employing a resin having a high adhesion with the plating film as a material (thermoplastic resin) of the outer annular portion. In such a case, the outer annular portion is preferably constructed in double layers including an outer layer and an inner layer of different materials.

Preferably, in the small-diameter cable having the configuration described above, the outer annular portion is formed of a resin capable of being plated with a metal, and the outer conductor layer can be formed by metal plating.

With this configuration, each strand of an ordinary stranded shield wire or a braided shield wire cannot be reduced in diameter to less than the limit of about 25 μm, for example. Also, when the wire is bent, the strands may be loosed open to form gaps, causing a signal leakage. In the case where the outer conductor layer is formed by metal plating, however, the thickness of the conductor layer can be reduced and therefore the diameter of the coaxial cable can be further reduced. Also, no gap is formed when the wire is bent.

Also, according to this invention, there is provided a small-diameter coaxial cable comprising a central conductor, an insulated covering layer arranged on the outer periphery of the central conductor and having air gaps continuous along the longitudinal direction and an outer conductor layer arranged on the outer periphery of the insulated covering layer, characterized in that the insulated covering layer includes an annular portion covering the outer periphery of the central conductor and one or more columnar (rib) portions extending outward from the annular portion, the outer conductor layer is arranged to be in contact with the outer periphery of the columnar portions, and one or more air gaps continuous along the longitudinal direction are formed on the inner side of the outer conductor layer.

With this configuration, one or more air gaps continuous along the longitudinal direction can be formed on the inner side of the outer conductor layer, and the equivalent dielectric constant between the central conductor and the outer conductor layer (insulated covering layer) can be reduced.

The outer conductor layer of the small-diameter coaxial cable having the configuration described above can be formed of a hollow compressed stranded wire.

With this configuration, the hollow compressed stranded wire (hollow stranded wire) has a self-supporting structure, and therefore can contain a linear object of an arbitrary shape having an outer diameter smaller than the inner diameter thereof. Also, by providing an insulated covering layer having a rib on the central conductor, the central conductor can be arranged at the center of the hollow stranded wire.

The hollow stranded wire has the strands in close contact with each other, and therefore forms no gap between the strands when bent. Also, since the strands are not bonded to each other, the flexibility is basically high.

The outer conductor layer of the small-diameter coaxial cable having the configuration described above can be formed in such a manner that a metal tape or a metal foil having a superior electrical conductivity such as copper or a metal laminate film produced by laminating the metal tape or the metal foil with a plastic film is wound on the outer periphery of the columnar portion.

With this configuration, the outer conductor layer is formed in such a manner that a metal tape or a metal foil having a superior electrical conductivity such as copper or a metal laminate film produced by laminating the metal tape or the metal foil with a plastic film is wound on the outer periphery of the columnar portion, and therefore, the small-diameter coaxial cable can be formed with relative ease using a simple means.

The small-diameter coaxial cable having the configuration described above can be formed in such a manner that a semi-finished product (insulating core) including the outer conductor layer of a metal pipe having a superior electrical conductivity such as copper and a covering layer having the columnar portions formed on the outer periphery of the central conductor is inserted into the metal pipe while at the same time drawing the metal pipe through a die.

With this configuration, a semi-finished product (insulating core) including the outer conductor layer of a metal pipe having a superior electrical conductivity such as copper and a covering layer having the columnar portions formed on the outer periphery of the central conductor is inserted into the metal pipe while at the same time drawing the metal pipe through a die, and therefore the small-diameter coaxial cable can be formed with relative ease.

In the small-diameter coaxial cable having the configuration described above, a plurality of the coupling portions and the columnar portions extend radially at equal angular intervals in the cross section and can be extended along the longitudinal axial direction of the small-diameter coaxial cable at the same angular intervals.

Also, the coupling portions and the columnar portions of the small-diameter coaxial cable having the configuration described above can be formed spirally along the longitudinal direction.

With these configurations, a plurality of the air gaps can be uniformly arranged along the peripheral direction around the central conductor. The air gaps, thus arranged uniformly, have a superior forming stability and a superior geometric accuracy. The columnar portions may be formed spirally by rotating the covering die.

In the small-diameter coaxial cable having the configuration described above, the annular portion, the coupling portions and the columnar portions can be formed by extruding fluoro resin such as FEP, PFA or PTFE or the synthetic resin such as APO (amorphous polyolefin) resin or PEN (polyethylene naphthalate).

With this configuration, the insulated cover is formed of fluoro resin selected from PFA (tetrafluoroethylene-Perfluoroalkyl vinyl ether copolymer), FEP (tetrafluoroethylene-hexafluoropropyrene copolymer) or PTFE (polytetrafluoroethylene), amorphous polyolefin resin or polyethylene naphthalate, and therefore the relative dielectric constant is low (3 or less) and the heat resistance is high.

The insulated covering layer of the small-diameter coaxial cable having the configuration described above can occupy at least 10% in area of the air gaps in the cross section.

With this configuration, the air gaps occupy the area of at least 10% of the insulated covering layer in cross section. By increasing the hollowness of the air gaps, the equivalent dielectric constant can be reduced. Preferably, therefore, the hollowness is increased to at least 50%, up to an upper limit of 90%, from the viewpoint of strength (passability through the processes) of the insulated covering layer.

In the small-diameter coaxial cable having the configuration described above, a protective covering layer can be formed on the outer periphery of the outer conductor layer so that the outermost diameter of the small-diameter coaxial cable can be set to not more than 1 mm.

According to this invention, there is provided a method of fabricating a small-diameter coaxial cable, characterized in that a covering die having a central hole for insertion of the central conductor therethrough and including a resin discharge portion having, a circular annular portion formed on the outer periphery of the central hole and a plurality of radial slits extending radially outward from the outer periphery of the circular annular portion is used in such a manner that the central conductor is inserted through the central hole while at the same time molding by extruding the melted thermoplastic resin, with a draft, from the resin discharge portion thereby to obtain an intermediate molded component including an inner annular portion covering the outer periphery of the central conductor and a plurality of coupling portions extending outward from the inner annular portion and similar in shape to the die, after which the intermediate molded component is introduced to the head of a melt extruder, and the outer annular portion is covered by extrusion on the coupling portions by an annular covering die thereby to form the insulated covering layer having the air gaps, after which the outer conductor layer and the protective covering layer are sequentially formed on the outer periphery of the insulated covering layer.

In the method of fabricating the small-diameter coaxial cable having the configuration described above, the insulated covering layer is formed in two stages. Since the layer is covered with a draft, the resin discharge portion of the die can be larger than the (intermediate) molded component. In this case, the draft makes it possible to position the central conductor easily at the center for an improved geometric accuracy while at the same time increasing the molding speed by reducing the discharge pressure.

Also, according to this invention, there is provided a method of fabricating a small-diameter coaxial cable, characterized in that the central conductor is covered by extrusion, with a draft, with the thermoplastic resin melted in annular fashion by an annular covering die thereby to obtain an intermediate molded component having an inner annular portion covering the outer periphery of the central conductor, after which using a die including a central hole and a resin discharge portion having an annular portion and a plurality of radial holes extending radially from the inner periphery of the annular portion, the intermediate molded component is inserted through the central hole while extruding the melted thermoplastic resin from the resin discharge portion with a draft thereby to form an outer annular portion and a plurality of coupling portions extending to the center, thereby forming the insulated covering layer having the air gaps, after which the outer conductor layer and the protective covering layer are sequentially formed and covered on the outer periphery of the insulated covering layer.

With this configuration, unlike the invention described in claim 13, the coupling portions and the outer annular portion are integrated and molded with a draft. In the process, the draft makes it possible to increase the size of the resin discharge portion of the die as compared with the shape of the (intermediate) molded component.

In this case, the draft makes it possible to position the central conductor at the center easily for an improved geometric accuracy. At the same time, the lower discharge pressure can increase the molding rate.

In the method of fabricating the small-diameter coaxial cable having the configuration described above, as an alternative to the process of producing the intermediate molded component, the dispersion with the thermoplastic resin particles dispersed in a dispersion medium (liquid) is coated or impregnated around the central conductor, after which the dispersion medium is evaporated thereby to form an annular covering on the central conductor or an annular covering is formed by powder coating thereby to form the inner annular portion and obtain an intermediate molded component having the inner annular portion covering the outer periphery of the central conductor.

With this configuration, the thickness of the annular covering around the central conductor can be reduced as compared with the thickness (to a limit of about 30 μm) obtained by the extrusion covering.

Further, according to this invention, there is provided a method of fabricating a small-diameter coaxial cable comprising a central conductor, an insulated covering layer arranged on the outer periphery of the central conductor and having air gaps continuous along the longitudinal direction, an outer conductor layer arranged on the outer periphery of the insulated covering layer and a protective covering layer arranged on the outer periphery of the outer conductor layer, characterized in that using a die having a central hole for inserting the central conductor therethrough and a plurality of T-shaped split holes arranged adjacently to each other on the outer periphery of the central hole, the central conductor is inserted through the central hole while at the same time extruding the melted resin from the central hole and the T-shaped split holes thereby to form the insulated covering layer having the air gaps continuous along the longitudinal direction on the outer periphery of the central conductor, after which the outer conductor layer and the protective covering layer are sequentially formed and covered on the outer periphery of the insulated covering layer.

With this configuration, using a die having an insertion hole for the central conductor and a plurality of T-shaped split holes arranged adjacently to each other on the outer periphery of the central hole, the central conductor is inserted into the central hole while at the same time extruding the melted resin from the central hole and the split holes thereby to form the insulated covering layer having the air gaps continuous along the longitudinal direction on the outer periphery of the central conductor in one stage.

In the method of fabricating the small-diameter coaxial cable having the configuration described above, the outer conductor layer can be formed by metal plating.

The metal plating is conducted in such a manner that the surface of the insulated covering is roughened and subjected to the hydrophilic process, after which the electroless plating and the electrolytic plating are conducted to form the outer conductor layer.

Also, according to this invention, there is provide a method of fabricating a small-diameter coaxial cable, characterized in that a covering die including a central hole for inserting the central conductor therethrough and a resin discharge portion having an annular portion and a plurality of radial slits extending radially outward from the outer periphery of the annular portion is used in such a manner that the central conductor is inserted through the central hole while at the same time molding by extrusion, with a draft, the melted thermoplastic resin from the resin discharge portion thereby to obtain an intermediate molded component (insulated core) similar in shape to the die and having an inner annular portion covering the outer periphery of the central conductor and a plurality of coupling portions extending outward from the inner annular portion, which intermediate molded component is supplied continuously so that an outer conductor layer is formed by covering a hollow compressed stranded wire or winding a metal foil, a laminate film or the like or covering by extending a copper pipe on the outer periphery of the columnar portions, after which an outer covering layer is formed on the outer periphery of the outer conductor layer.

### BRIEF DESCRIPTION OF THE DRAWINGS

FIG. 1 is a sectional view showing a small-diameter coaxial cable according to a first embodiment of the invention;

FIG. 2 is a perspective view showing a small-diameter coaxial cable according to a second embodiment of the invention;

FIG. 3 is a sectional view showing a small-diameter coaxial cable according to a third embodiment of the invention;

FIG. 4 is a sectional view showing a small-diameter coaxial cable according to a fourth embodiment of the invention;

FIG. 5 is a sectional view showing a small-diameter coaxial cable according to a fifth embodiment of the invention;

FIG. 6 is a perspective view showing a small-diameter coaxial cable according to a sixth embodiment of the invention;

FIG. 7 is a diagram for explaining the covering die used in a first specific example of the method of fabricating the small-diameter coaxial cable according to this invention;

FIG. 8 is a sectional view for explaining an intermediate molded component obtained during the fabrication in the first specific example of the method of fabricating the small-diameter coaxial cable according to this invention;

FIG. 9 is a sectional view for explaining a second intermediate molded component obtained during the fabrication in the first specific example of the method of fabricating the small-diameter coaxial cable according to this invention;

FIG. 10 is a diagram for explaining the covering die used in a third specific example of the method of fabricating the small-diameter coaxial cable according to the invention; and

FIG. 11 is a sectional view for explaining an intermediate molded component obtained during the fabrication in the third specific example of the method of fabricating the small-diameter coaxial cable according to this invention.

### BEST MODE FOR CARRYING OUT THE INVENTION

The mode for carrying out the invention is explained in more detail below with reference to embodiments and specific examples.

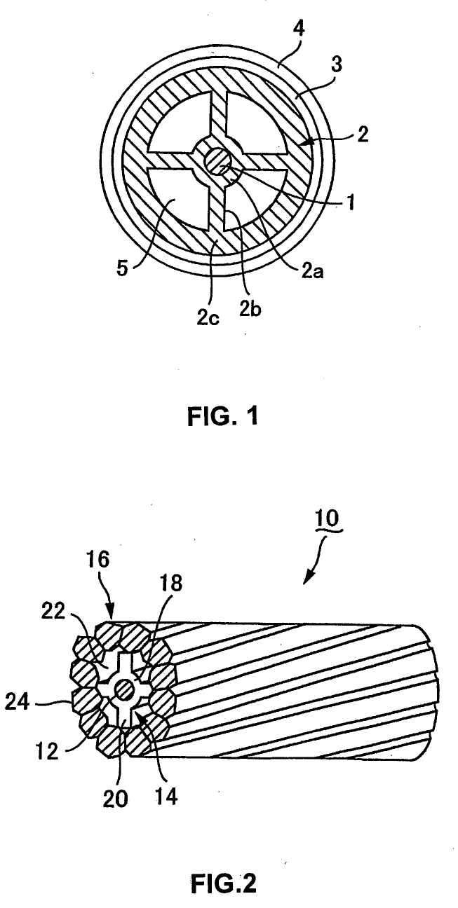

FIG. 1 shows a small-diameter coaxial cable according to a first embodiment of the invention. The small-diameter coaxial cable shown in the drawing comprises a central conductor 1, an insulated covering layer 2, an outer conductor layer 3 and a protective covering layer 4.

The central conductor 1 is configured of a thin wire of copper or copper alloy high in strength and electrical conductivity or a solid wire or a stranded wire of the thin wire plated with a metal higher in electrical conductivity. To obtain a coaxial cable smaller in diameter, however, the solid wire is desirably used.

The insulated covering layer 2 is formed of a thermoplastic resin and includes an inner annular portion 2a covering the outer periphery of the central conductor 1, four coupling portions 2b radially extending outward from the outer periphery of the inner annular portion 2a, and an outer annular portion 2c for coupling the outer ends of the coupling portions 2b to each other.

According to this embodiment, the four coupling portions 2b are arranged at equal angular intervals along the peripheral direction, so that four air gaps 5 continuous along the longitudinal direction are equidistantly arranged along the peripheral direction around the central conductor 1. Thus, a small space of each air gap 5 is defined by the coupling portions 2b.

The air gaps 5 are not limited to four but may be at least one in number, and formed in such a manner that each outer end portion thereof fails to reach the outer peripheral edge of the insulated covering layer 2, i.e. the outer edge of the outer annular portion 2c.

The insulated covering layer 2 having a plurality of the air gaps 5 continuous along the longitudinal direction is fabricated by any one of three methods. In the first method, using a covering die comprising a central hole for inserting the central conductor 1 therethrough and a resin discharge portion configured of, a circular annular portion and a plurality of radial slits extending radially from the outer periphery of the annular portion, the central conductor 1 is inserted into the central hole while at the same time molding by extrusion a melted thermoplastic resin from the resin discharge portion with a draft thereby to obtain an intermediate molded component, similar in shape to the die, including an inner annular portion 2a covering the outer periphery of the central conductor 1 and a plurality of the coupling portions 2b extending outward from the inner annular portion 2a, after which the intermediate molded component is introduced to the head of a melt extruder, so that an outer annular portion 2c is covered by extrusion on the coupling portions 2b using the circular annular covering die, after which an outer conductor layer 3 and a protective covering layer 4 are sequentially formed on the outer periphery of the insulated covering layer 2.

In the second method, the central conductor 1 is inserted through a circular annular covering die, and the melted thermoplastic resin is covered by extrusion in annular fashion on the outer periphery thereof with a draft thereby to obtain an intermediate molded component having an inner annular portion 2a covering the outer periphery of the central conductor 1, after which using a die including a central hole for inserting the intermediate molded component therethrough and a resin discharge portion having a circular annular portion forming an outer annular portion and a plurality of radial holes extending radially from the inner periphery of the annular portion toward the center, the intermediate molded component is inserted through the central hole while at the same time extruding the melted thermoplastic resin from the resin discharge portion with a draft thereby to form an outer annular portion 2c and a plurality of coupling portions 2b extending toward the center so that an insulated covering layer 2 having the air gaps 5 are formed, after which an outer conductor layer 3 and a protective covering layer 4 are sequentially formed on the outer periphery of the insulated covering layer 2.

In the third method, as an alternative to the process of producing the intermediate molded component in the second method, a dispersion with thermoplastic resin particles dispersed in a dispersion medium (liquid) is coated or impregnated around the central conductor, after which the dispersion medium is evaporated thereby to form an annular cover on the central conductor or to form an annular cover by powder coating. In this way, the inner annular portion is formed and an intermediate molded component having the thin inner annular portion covering the outer periphery of the central conductor is obtained, after which by the same process as in the second method, an outer annular portion 2c and a plurality of coupling portions 2b extending toward the center are formed thereby to form the insulated covering layer having the air gaps, after which an outer conductor layer 3 and a protective covering layer 4 are sequentially covered on the outer periphery of the insulated covering layer 2.

The outer conductor layer 3 is covered on the outer periphery of the insulated covering layer 2. In the case where this outer conductor layer 3 is formed by metal plating, the insulated covering layer 2 is activated by the plasma treatment, the flame treatment, the treatment by a strong acid such as chromic acid or sulfuric acid or the etching process with sulfuric acid, phosphoric acid or chromic acid (dichromic acid) aqueous solution, followed by sensitization with the hydrochloric acid solution of tin chloride, further followed by activation with the hydrochloric acid solution of palladium chloride, and then the electroless plating is conducted.

In this case, the metal plating layer may be a double structure including an electroless plating anchor metal layer and an electrically conductive metal layer formed on the outer periphery of the electroless plating anchor metal layer.

The insulated covering layer 4 formed on the outermost periphery, though not necessarily required, is formed to cover the outer conductor layer 3 according to this embodiment. This insulated covering layer 4 is formed by extrusion of, for example, FEP or polyvinyl chloride resin (PVC) or coating of acrylic resin or polyimide resin. By the way, the small-diameter coaxial cable shown in FIG. 1 can be reduced to a sufficiently small diameter as long as the outermost diameter is not more than 1 mm.

FIG. 2 shows a small-diameter coaxial cable according to a second embodiment of the invention. The small-diameter coaxial cable shown in the drawing comprises a central conductor 12, an insulated covering layer 14 and an outer conductor layer 16. The central conductor 12 is configured of, for example, a copper wire having a circular cross section.

The insulated covering layer 14 is electrically insulative, and according to this embodiment, includes an annular portion 18 covering the outer periphery of the central conductor 12 and columnar portions 20 projected from the outer periphery of the annular portion.

The insulated covering layer 14 is such that the annular portion 18 and the columnar portion 20 can be formed integrally by extrusion molding of the fluoro resin such as FEP or PFA or the synthetic resin such as amorphous polyolefin resin or PEN (polyethylene naphthalate) on the outer periphery of the central conductor.

According to this embodiment, the insulated covering layer 14 includes four columnar portions 20 each extending outward from the center and has a generally cross-shaped cross section. The columnar portions 20 extend radially at equal angular intervals (90° C.) in the cross section, while at the same time linearly extending with the same intervals along the longitudinal axial direction of the small-diameter coaxial cable 10.

The outer conductor layer 16 is formed in contact with the outer periphery of the columnar portions 20 of the insulated covering layer, and four air gaps 22 continuous along the longitudinal direction of the small-diameter coaxial cable 10 are defined by the columnar portions 20 on the inner side of the outer conductor layer 16.

According to this embodiment, the outer conductor layer 16 is formed by a hollow compressed stranded wire. This compressed stranded wire is formed as a hollow wire by arranging a plurality of strands 24 on the same circumference and twisting each strand 24 in one direction while at the same time passing it through a compression die, so that the hollow shape is maintained without being deformed. The outermost diameter of the small-diameter coaxial cable 10 according to this embodiment can be maintained at not more than 1 mm.

In the small-diameter coaxial cable 10 having the configuration described above, the four air gaps 22 continuous along the longitudinal direction are formed on the inner side of the outer conductor layer 16, and therefore the dielectric constant between the central conductor and the outer conductor can be reduced.

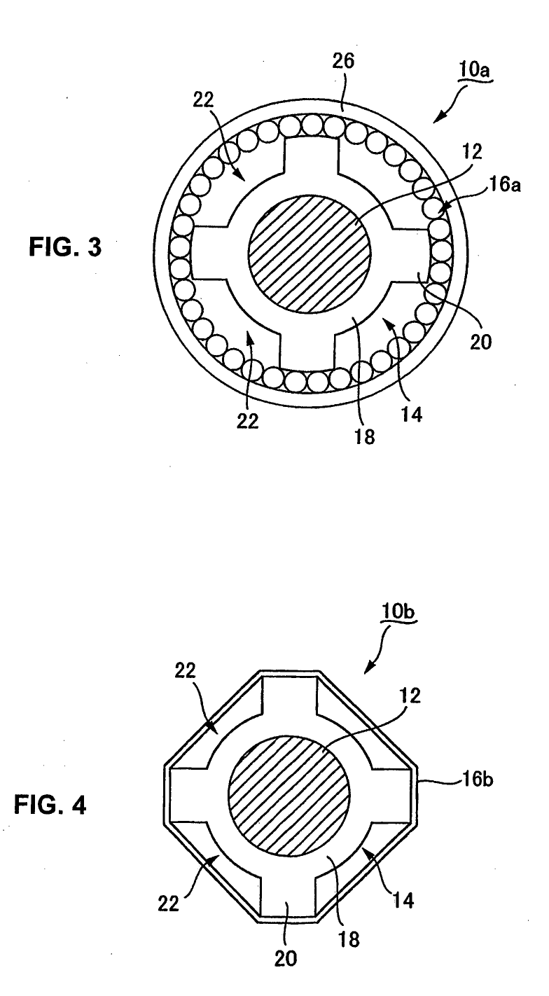

FIG. 3 shows a small-diameter coaxial cable according to a third embodiment of the invention. The component parts identical or equivalent to those in the embodiments described above are designated by the same reference numerals, respectively, and not described again, and only the features of them are described below.

The embodiment shown in FIG. 3 is a modification of the second embodiment, and a protective covering layer 26 of an electrically insulating characteristic is formed on the outer periphery of the outer conductor layer 16a configured of the hollow compressed stranded wire of the second embodiment. The small-diameter coaxial cable 10a having this configuration also has the functions and effects equivalent to those of the second embodiment.

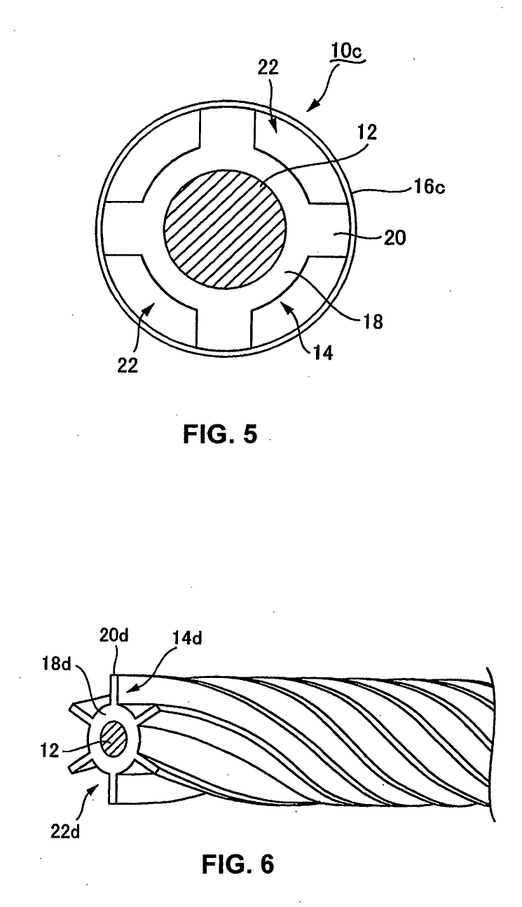

FIG. 4 shows a small-diameter coaxial cable according to a fourth embodiment of the invention. The component parts identical or equivalent to those in the embodiments described above are designated by the same reference numerals, respectively, and not described again, and only the features of them are described below.

The embodiment shown in FIG. 4 comprises a central conductor 12 and an insulated covering layer 14 of the same configuration as that of the second embodiment, except that the outer conductor layer 16b has a feature.

Specifically, according to this embodiment, the outer conductor layer 16b is formed of a metal tape or a metal foil having a superior electrical conductivity such as copper or a metal laminate film with the metal tape or the metal foil laminated with a plastic film. The member selected from them is wound on the outer periphery of the columnar portions 20.

In this case, the tape, etc. is wound in such a manner that no gap is formed along the longitudinal axial direction of the cable. The small-diameter coaxial cable 10b having this configuration has also the functions and effects equivalent to those of the second embodiment.

FIG. 5 shows a small-diameter coaxial cable according to a fifth embodiment of the invention. The component parts identical or equivalent to those of the embodiments described above are designated by the same reference numerals, respectively, and not described again, and only the features thereof are described below.

The embodiment shown in FIG. 5 comprises a central conductor 12 and an insulated covering layer 14 of the same configuration as in the second embodiment, except that the outer conductor layer 16c has a feature.

Specifically, according to this embodiment, the outer conductor layer 16c is formed of a metal pipe having a superior electrical conductivity such as copper, and a semi-finished product formed with the insulated covering layer 14 having the columnar portions 20 on the outer periphery of the central conductor 12 is inserted into a metal pipe while drawing and extending the metal pipe through a die. The small-diameter coaxial cable 10c having this configuration also has the functions and effects equivalent to those of the second embodiment.

By the way, in the fourth and fifth embodiments shown in FIGS. 4 and 5, the protective covering layer shown in the first embodiment can be formed on the outer periphery of the outer conductor layer 16b, 16c.

FIG. 6 shows a small-diameter coaxial cable according to a sixth embodiment of the invention. The component parts identical or equivalent to those of the embodiments described above are designated by the same reference numerals, respectively, and not described again, and only the features of this embodiment are described below.

This embodiment has the external appearance shown in FIG. 6 as a semi-finished product formed with the insulated covering layer 14d on the outer periphery of the central conductor 12, and the insulated covering layer 14d includes an annular portion 18d and a columnar portions 20d.

The annular portion 18d, like in the second embodiment, covers the outer periphery of the central conductor 12 in annular fashion. The columnar portions 20d, on the other hand, which constitute a structure of six columns extending outward from the center in such a manner as to be wound spirally at predetermined pitches on the outer periphery of the annular portion 18d. The columnar portions 20d can be formed by rotating the die in one direction while extruding the melted synthetic resin. Only one columnar portion 20 may be used depending on the spiral pitch.

According to this embodiment, once either one of the outer conductor layers 16a, 16b in the embodiments described above is formed on the outer periphery of the columnar portions 20d, the spiral air gaps 22d are formed therein, and therefore the functions and effects equivalent to those of the above-mentioned embodiments are obtained.

More specific examples of the small-diameter coaxial cable and the method of fabrication thereof according to the invention are explained with reference to comparative examples. This invention, however, is not limited to the specific examples described below.

### SPECIFIC EXAMPLE 1

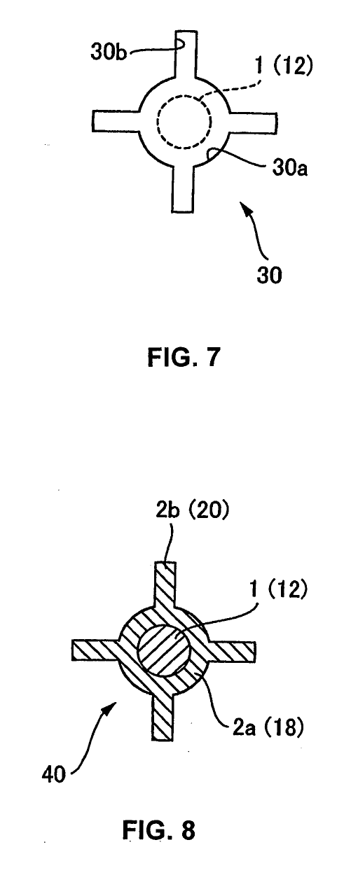

The central conductor (silver-plated copper wire having the outer diameter φ of 0.1 mm) 1 was heated, so that the surface temperature became 100° C., by a heater using an electric burner, introduced to a cross head die and inserted through a covering die (nozzle) 30 having the shape shown in FIG. 7.

The covering die 30 shown in FIG. 7 includes a central hole 30a for inserting the central conductor 1 therethrough, and four radial split holes (resin discharge holes) 30b formed on the outer peripheral edge of the central hole 30a and extending radially outward.

The inner diameter of the central hole 30a is larger than the outer diameter of the central conductor 1, and once the central conductor 1 was inserted through the central hole 30a, predetermined gaps (resin discharge portions) were formed between the outer periphery of the conductor 1 and the central hole 30a and the resin is discharged into these gaps.

Also, the four slit holes 30b had substantially the same shape as the coupling portions 2b and were equidistantly arranged along the peripheral direction around the central hole 30a.

Using the covering die 30 shaped like this, the central conductor 1 was inserted through the central hole 30a, while at the same time being taken off at the rate of 30 m/min. At the same time, the cyclic polyolefin (trade name ZEONEX RS820 of ZEON Corporation) having a relative dielectric constant of 2.27 was covered by being extruded, with a draft, at the extrusion temperature of 270° C. from the resin discharge portions defined by the periphery of the central hole 30a and the slit holes 30b. In this way, a generally cross-shaped intermediate molded component 40 shown in FIG. 8 was obtained.

In this intermediate molded component 40, an annular inner portion 2a is formed on the outer periphery of the central conductor 1, and four coupling portions 2b are formed extending radially on the outer periphery of the inner annular portion 2a.

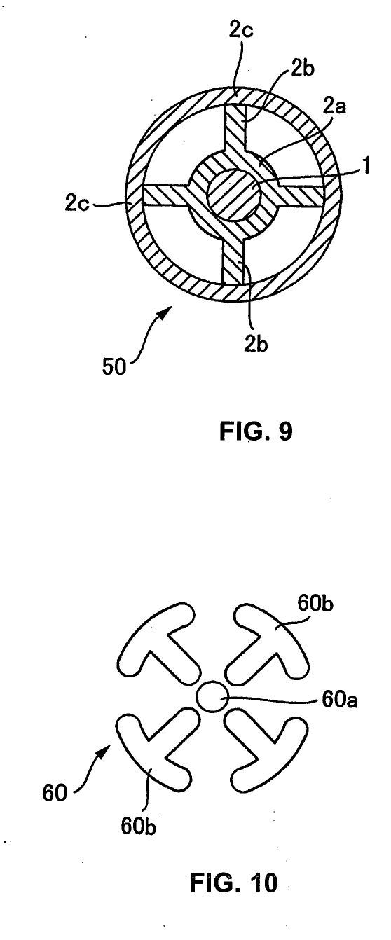

Next, the intermediate molded component 40 thus obtained was introduced to a circular pipe covering die and covered like a pipe using the same annular polyolefin thereby to form an insulated covering layer 2 shown in FIG. 9.

The second intermediate molded component 50 formed with the insulated covering layer 2 included an inner annular portion 2a covering the outer periphery of the central conductor 1, four coupling portions 2b radially extending outward from the outer periphery of the inner annular portion, and an outer annular portion 2c connecting the outer ends of the coupling portions 2b to each other. The second intermediate molded component 50 thus had a hollow section with four air gaps 5 at the hollowness of 30% and the outer diameter φ of 0.32 mm.

Next, the second intermediate molded component 50 thus obtained was etched by an aqueous mixture solution of sulfuric acid, phosphoric acid and chromic acid, sensitized by the hydrochloric acid solution of tin chloride, activated by the hydrochloric acid solution of palladium chloride, and plated in electroless and electrolytic fashions with copper thereby to obtain an outer conductor layer 3 having the thickness of 0.015 mm.

After that, PVC of 0.04 mm thickness was covered as a protective covering layer 4. In this way, a small-diameter coaxial cable having an outer diameter φ of 0.43 mm was obtained. In the process, the outer conductor layer 3 formed by plating was sufficiently adhered to the insulated covering layer 2 and not separated while passing through the guides in the process of forming the protective covering layer 4.

The small-diameter coaxial cable thus obtained had a cross-sectional structure as shown in FIG. 1, in which the air gaps occupied 30% of the area of the insulated covering layer 2, the equivalent dielectric constant was 1.89 and the characteristic impedance was 50 Ω.

Also, the air gaps 5 were formed at totally inner side of the insulated covering layer 2, and therefore not intruded by moisture or the like in the plating processes, thereby preventing the relative dielectric constant from rising.

### COMPARATIVE EXAMPLE 1

The central conductor (silver-plated copper wire having the outer diameter φ of 0.1 mm) 1 was heated, so that the surface temperature became 100° C., by a heater using an electric burner and introduced to a cross head die, and while being taken off at the rate of 30 m/min, cyclic polyolefin (trade name ZEONEX RS820 of ZEON Corporation) having a relative dielectric constant of 2.27 was covered by being extruded through a circular pressure die at the extrusion temperature of 270° C. The covering conductor thus obtained was treated the same way as in the first specific example thereby to obtain a small-diameter coaxial cable.

In this small-diameter coaxial cable, the outer diameter of the insulated covering layer was required to be increased to secure the characteristic impedance of 50 Ω, resulting in an increased cable outer diameter φ of 0.46 mm.

### SPECIFIC EXAMPLE 2

The central conductor (silver-plated copper wire having an outer diameter φ of 0.1 mm) was heated so that the surface temperature became 100° C. by a heater using an electric burner, and then introduced to a cross head die. The central conductor 1, while being inserted through the central hole 30a as in the first specific example, was taken off at the rate of 30 m/min. At the same time, FEP (trade name NP-100 of Daikin Kogyo Co., Ltd.) having a relative dielectric constant of 2.1 was covered by being extruded at the extrusion temperature of 350° C., with a draft, from the resin discharge portions defined by the periphery of the central holes 30a and the slit holes 30b. In this way, a generally cross-shaped intermediate molded component 40 shown in FIG. 8 was obtained.

Next, the intermediate molded component 40 thus obtained was introduced to a circular pipe covering die and covered by extrusion in annular fashion with cyclic polyolefin (trade name ZEONEX RS820 of ZEON Corporation) having a relative dielectric constant of 2.27 at the extrusion temperature of 270° C. thereby to form the outer annular portion 2c connecting the outer ends of the coupling portions 2b to each other. In this way, a second intermediate molded component 50 having the cross section shown in FIG. 9 was obtained.

Next, the second intermediate molded component 50 thus obtained was etched by an aqueous mixture solution of sulfuric acid, phosphoric acid and chromic acid, sensitized by hydrochloric acid solution of tin chloride, activated by the hydrochloric acid solution of palladium chloride, and plated in electroless and electrolytic fashions with copper thereby to obtain an outer conductor layer 3 having the thickness of 0.015 mm. After that, a FEP covering having a thickness of 0.04 mm was applied as a protective covering layer 4 thereby to obtain a small-diameter coaxial cable of 0.42 mm in outer diameter. In the process, the outer conductor layer 3 formed by plating was sufficiently bonded with the insulated covering layer 2, and not separated while passing through the guides in the process of forming the protective covering layer 4.

The small-diameter coaxial cable thus obtained had a cross section in the shape shown in FIG. 1, in which the air gaps 5 represents 30% of the insulated covering layer 2, the equivalent dielectric constant was 1.82 and the characteristic impedance was 50 Ω. Also, as in the first specific example, the air gaps 5 were not intruded by water or the like in the plating process nor the relative dielectric constant increased.

The small-diameter coaxial cable thus obtained can be connected with a connector using solder without melting the insulated covering portion 2.

### SPECIFIC EXAMPLE 3

The central conductor (silver-plated copper wire having the outer diameter φ of 0.1 mm) 1 was heated so that the surface temperature became 100° C. by a heater using an electric burner, introduced to a cross head die and inserted into a covering die (nozzle) 60 in the shape shown in FIG. 10.

The die 60 shown in FIG. 10 includes a central hole 60a for inserting the central conductor 1 therethrough, and four split holes 60b formed adjacently to each other on the outer periphery of the central hole 60a. The inner diameter of the central hole 60a is larger than the outer diameter of the central conductor 1.

The four split holes 60b have substantially the same shape and are arranged equidistantly along the peripheral direction around the center hole 60a. These generally T-shaped split holes 60b each include an arcuate portion and a base formed from the center of the arcuate portion.

The edge of the base of each T-shaped split hole 60b is arranged in proximity to the outer periphery of the central hole 60a, so that the edges of the arcuate portions arranged adjacently along the peripheral direction are arranged in proximity to each other. Using the die of this shape, the central conductor 1 is inserted through the central hole 60a, while at the same time covering by extruding cyclic polyolefin (trade name: ZEONEX RS820 of ZEON Corporation) having a relative dielectric constant of 2.27 at the extrusion temperature of 270° C. from the central hole 60a and the T-shaped split holes 60b thereby to form an insulated covering layer 2 on the outer periphery of the central conductor 1.

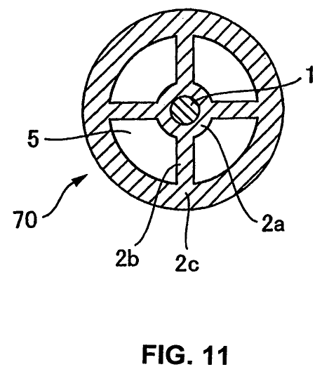

The intermediate molded component 70 formed with the insulated covering layer 2, as shown in FIG. 11, includes an inner annular portion 2a covering the outer periphery of the central conductor 1, four coupling portions 2b radially extending outward from the outer periphery of the inner annular portion 2a and an outer annular portion 2c connecting the outer ends of the coupling portions 2b to each other. The intermediate molded component 70 had a cross section 30% in hollowness and an outer diameter φ of 0.32 mm.

Next, the intermediate molded component 70 thus obtained was etched by an aqueous mixture solution of sulfuric acid, phosphoric acid and chromic acid, sensitized by hydrochloric acid solution of tin chloride, activated by the hydrochloric acid solution of palladium chloride, and plated in electroless and electrolytic fashions with copper thereby to obtain an outer conductor layer 3 having the thickness of 0.015 mm. After that, PVC of 0.04 mm thickness was covered as a protective covering layer 4. In this way, a small-diameter coaxial cable having an outer diameter φ of 0.43 mm was obtained.

In the process, the outer conductor layer 3 formed by plating was sufficiently adhered to the insulated covering layer 2 and not separated while passing through the guides in the process of forming the protective covering layer 3.

The small-diameter coaxial cable thus obtained had a cross-sectional structure as shown in FIG. 1. The air gaps occupied 30% in area of the insulated covering layer 2, the equivalent dielectric constant was 1.89 and the characteristic impedance was 50 Ω.

Also, the air gaps 5 were formed totally within the insulated covering layer 2, and therefore not intruded by moisture or the like in each plating process, thereby preventing the relative dielectric constant from rising.

### SPECIFIC EXAMPLE 4

The central conductor (silver-plated copper wire having an outer diameter φ of 0.1 mm) 12 was heated so that the surface temperature became 100° C. by a heater using an electric burner, and then introduced to a cross head die. The central conductor 1, while being inserted through the central hole 30a as in the first specific example, was taken off at the rate of 30 m/min. At the same time, FEP (trade name NP-100 of Daikin Kogyo Co., Ltd.) having a relative dielectric constant of 2.1 was covered by being extruded at the extrusion temperature of 350° C., with a draft, from the resin discharge portion defined by the periphery of the central hole 30a and the slit holes 30b. In this way, a substantially cross-shaped intermediate molded component 40 shown in FIG. 8 was obtained.

The cross section of the intermediate molded component 40 was in the shape of a cross including an annular portion 18 on the outer periphery of the central conductor 12 an ribs (columnar portions) 20. The rib thickness was 0.06 mm, the rib including the forward thereof has a maximum width was 0.28 mm, and the virtual circular hollow portion formed by connecting the forward ends of the ribs had a hollowness of 50%.

Next, 37 silver-plated copper wires constituting strands 24 and having the size of 0.03 mm were arranged on the virtual circumference connecting the forward ends of the ribs 20 of the intermediate molded component 40, which was introduced into a compression die having an outer diameter of 0.34 mm. While rotating the winder, the strands were twisted to produce a hollow compressed stranded wire. As a result, a coaxial cable 10 comprising an outer conductor layer 16 having an outer diameter of 0.34 mm was obtained as shown with a roughly illustrated stranded wire in FIG. 2.

Next, the cable 10 thus obtained was introduced to the cross head die and while being taken off at the take-off speed of 11 mm/min, formed with a protective cover 26 of FEP resin (trade name: NP-100 of Daikin Kogyo Co., Ltd.) having a thickness of 0.04 mm by a covering die. In this way, a small-diameter coaxial cable of substantially the same structure as the small-diameter coaxial cable 10a shown in FIG. 3 and having the final outer diameter of 0.42 mm was obtained.

The characteristic impedance of the small-diameter coaxial cable thus obtained was measured and found to be 50 Ω. Also, the equivalent dielectric constant of the insulated covering layer 14 was 1.55.

### COMPARATIVE EXAMPLE 2

As in the specific example 4, a silver-plated copper wire of 0.1 mm was used as the central conductor 12. To obtain the characteristic impedance of 50 Ω, the diameter after forming the covering layer was 0.33 mm in terms of FEP resin (relative dielectric constant 2.1).

In order to satisfy this specification, the central conductor of 0.1 mm was introduced to the cross head die and passed through a circular pressure die at the take-off speed of 11 m/min. In this way, FEP resin (trade name: NP-100 of Daikin Kogyo Co., Ltd.) was covered to 0.33 mm at the extrusion temperature of 350° C.

Next, the shield wire was stranded on this insulated covering conductor having an outer diameter of 0.33 mm was stranded at the rate of 2 m/min by a spiral winder. The shield wire was comprised of 38 silver-plated copper strands of 0.03 mm. As a result, a coaxial cable of 0.39 mm was obtained comprising the central conductor 12, the insulated covering layer and the outer conductor layer.

Next, the cable thus obtained was introduced to the cross head die, and while being taken off at the take-off speed of 11 m/min, FEP resin (trade name NP-100 of Daikin Kogyo, Co., Ltd.: relative dielectric constant 2.1) was covered to the thickness of 0.04 mm, with a draft, by a circular covering die. The final outer diameter was 0.47 mm.

### INDUSTRIAL APPLICABILITY

The small-diameter coaxial cable and the method of fabrication thereof according to the invention realize a superior, stable high-frequency characteristic and electrical characteristics, and therefore can effectively find applications in reducing the size and thickness of information device terminals such as the notebook-sized personal computer.

1. A small-diameter coaxial cable comprising a central conductor, an insulated covering layer arranged on the outer periphery of the central conductor and having air gaps continuous along the longitudinal direction, and an outer conductor layer arranged on the outer periphery of the insulated covering layer;
said insulated covering layer including an inner annular portion covering the outer periphery of the central conductor, a plurality of coupling portions extending outward from the inner annular portion and an outer annular portion connecting the outer peripheral edges of the coupling portions to each other, the coupling portions defining the peripheral direction of the air gaps.

2. A small-diameter coaxial cable as described in claim 1, wherein the inner annular portion and the coupling portions combined with the outer annular portion, the inner annular portion combined with the coupling portions and the outer annular portion, or the outer annular portion is formed in two layers of different types of resin.

3. A small-diameter coaxial cable as described in claim 1 or 2, wherein the outer annular portion is formed of a resin capable of being plated with a metal, and the outer conductor layer is formed by plating a metal.

4. A small-diameter coaxial cable comprising a central conductor, an insulated covering layer arranged on the outer periphery of the central conductor and having air gaps continuous along the longitudinal direction, and an outer conductor layer arranged on the outer periphery of the insulated covering layer;
said covering layer including an annular portion covering the outer periphery of the central conductor, one or more columnar portions (ribs) extending outward from the annular portion, the outer conductor layer is arranged to be in contact with the outer periphery of the columnar portions, and one or more air gaps continuous along the longitudinal direction are formed on the inner side of the outer conductor layer.

5. A small-diameter coaxial cable as described in claim 4, wherein the outer conductor layer is formed of a hollow compressed stranded wire.

6. A small-diameter coaxial cable as described in claim 4, wherein the outer conductor layer is formed by winding the outer periphery of the columnar portions with a metal tape or a metal foil of superior electrical conductivity such as copper or a metal laminate film including the metal tape or the metal foil laminated with a plastic film.

7. A small-diameter coaxial cable as described in claim 4, wherein the outer conductor layer is formed of a metal pipe superior in electrical conductivity such as copper, and a semi-finished product (insulated core) formed with a covering layer having the columnar portions is inserted into the metal pipe while drawing and extending the metal pipe through a die.

8. A small-diameter coaxial cable as described in any one of claims 1, 2 or 4, wherein a plurality of the coupling portions and a plurality of the columnar portions are extended radially at equal angular intervals in the cross section while at the same time being extended along the longitudinal axial direction of the small-diameter coaxial cable with the same intervals.

9. A small-diameter coaxial cable as described in any one of claims 1, 2 or 4, wherein the coupling portions and the columnar portions are formed spirally along the longitudinal direction.

10. A small-diameter coaxial cable as described in any one of claims 1, 2 or 4, wherein the annular portion, the coupling portions and the columnar portions are formed by extruding fluoro resin such as FEP, PFA or PTFE or synthetic resin such as APO (amorphous polyolefin) or PEN (polyethylene naphthalate).

11. A small-diameter coaxial cable as described in any one of claims 1 or 4, wherein the insulated covering layer occupies not less than 10% of the area of the air gaps in the cross section.

12. A small-diameter coaxial cable as described in any one of claims 1 or 4, wherein a protective covering layer is formed on the outer periphery of the outer conductor layer.

13. A method of fabricating a small-diameter coaxial cable, comprising:
a covering die including a central hole for insertion of the central conductor therethrough and a resin discharge portion having a circular annular portion formed on the outer periphery of the central hole and a plurality of radial slits extending radially outward from the outer periphery of the circular annular portion is used in such a manner that the central conductor is inserted through the central hole while at the same time molding by extruding the melted thermoplastic resin, with a draft, from the resin discharge portion thereby to obtain an intermediate molded component including an inner annular portion covering the outer periphery of the central conductor and a plurality of coupling portions extending outward from the inner annular portion and similar in shape to the die,
after which the intermediate molded component is introduced to the head of a melt extruder, and the outer annular portion is covered by extrusion on the coupling portions by an annular covering die thereby to form the insulated covering layer having the air gaps,
after which the outer conductor layer and the protective covering layer are sequentially formed on the outer periphery of the insulated covering layer.

14. A method of fabricating a small-diameter coaxial cable, that comprising:
a central conductor covered by an extrusion with the thermoplastic resin melted in annular fashion, with a draft, by an annular covering die thereby to obtain an intermediate molded component having an inner annular portion covering the outer periphery of the central conductor,
after which using a die including a central hole, an annular portion and a resin discharge portion having a plurality of radial holes extending radially from the inner periphery of the annular portion, the intermediate molded component is inserted through the central hole while extruding the melted thermoplastic resin from the resin discharge portion with a draft thereby to form an outer annular portion and a plurality of coupling portions extending to the center, thereby forming the insulated covering layer having the air gaps,
after which the outer conductor layer and the protective covering layer are sequentially formed and covered on the outer periphery of the insulated covering layer.

15. A method of fabricating a small-diameter coaxial cable as described in claim 14, wherein in place of the process of obtaining the intermediate molded component,
a dispersion in which the thermoplastic resin particles is dispersed in a dispersion medium (liquid) is coated or impregnated around the central conductor, after which the dispersion medium is evaporated thereby to form an annular covering on the central conductor or an annular covering is formed by powder coating thereby to form the inner annular portion and obtain an intermediate molded component having the inner annular portion covering the outer periphery of the central conductor.

16. A method of fabricating a small-diameter coaxial cable comprising a central conductor, an insulated covering layer arranged on the outer periphery of the central conductor and having air gaps continuous along the longitudinal direction, an outer conductor layer arranged on the outer periphery of the insulated covering layer and a protective covering layer arranged on the outer periphery of the outer conductor layer, comprising:
using a die having a central hole for inserting the central conductor therethrough and a plurality of T-shaped split holes arranged adjacently to each other on the outer periphery of the central hole, the central conductor is inserted through the central hole while at the same time extruding the melted resin from the central hole and the T-shaped split holes thereby to form the insulated covering layer having the air gaps continuous along the longitudinal direction on the outer periphery of the central conductor,
after which the outer conductor layer and the protective covering layer are sequentially formed and covered on the outer periphery of the insulated covering layer.

17. A method, of fabricating a small-diameter coaxial cable as described in any one of claims 13 to 16, wherein the outer conductor layer is formed by plating a metal.

18. A method of fabricating a small-diameter coaxial cable, comprising a covering die including a central hole for inserting a central conductor therethrough and a resin discharge portion having an annular portion and a plurality of radial slits extending radially outward from the outer periphery of the annular portion is used in such a manner that the central conductor is inserted through the central hole while at the same time molding by extrusion, with a draft, the melted thermoplastic resin from the resin discharge portion thereby to obtain an intermediate molded component (insulated core) similar in shape to the die and having an inner annular portion covering the outer periphery of the central conductor and a plurality of coupling portions extending outward from the inner annular portion, which intermediate molded component is supplied continuously so that an outer conductor layer is formed by covering a hollow compressed stranded wire or winding a metal foil, a laminate film or the like or covering by extending a copper pipe on the outer periphery of the columnar portions, after which an outer covering layer is formed on the outer periphery of the outer conductor layer.
